(19) United States
(12) Patent Application Publication
(10) Pub. No.: US 2005/0030298 A1
(43) Pub. Date: Feb. 10, 2005

(54) Stylus for use with a hand held computer

(76) Inventor: Panageotes Philis, Kearny, NJ (US)

Correspondence Address: ANTHONY D. CIPOLLONE, ESQ., Suite 215, 15 Main Street, Hackensack, NJ, 07601, US

(21) Appl. No.: 10/634,494

(22) Filed: Aug. 6, 2003

(51) Int. Cl. G09G 5/00

(52) U.S. Cl. 345/179

(57) ABSTRACT

A hand held computer stylus comprising a hollow cylindrical body of plastic or metal into which is inserted a stem with a felt tip similar to an inkless ball pen which is used on a hand held computer which is responsive with the lightest touch and does not scratch or mar the screen.

### BACKGROUND OF THE INVENTION

1. Field of the Invention

The present invention generally involves the field of technology pertaining to a stylus for use with hand held computer.

2. Description of Prior Art

Hand held computers are well known in the art. However, none to date have employed the novel features of the present invention, which involves a unique stylus for use with hand held computer.

Numerous innovations for hand held computer have been provided in the prior that are described as follows.

Even though these inventions must be suitable for the specific individual purposes to which they address, they differ from the present invention as hereinafter contrasted.

U.S. Pat. No. 5.133.076 introduced the hand held computer.

U.S. Pat. No. 5,325,1110 discloses a method and apparatus for using and moving a tool such as an eraser on a physical display whose width can't be changed.

U.S. Pat. No. 5,369,262 introduces an electronic stylus type with optical reader.

U.S. Pat. No. 5,517,579 describes a handwriting recognition apparatus including a handwriting input device employing at least two different sensing techniques to sense handwriting and symbol identification apparatus for handwriting recognition.

U.S. Pat. No. 5,576,502 shows a pointing unit and improved stylus pen.

U.S. Pat. No. 5,883,338 describes telemetry by digitizer stylus.

U.S. Pat. Reissue No. 36,455 introduces a combination scanning and digitizing device in which the same photo-detectors are cooperatively used to scan graphic information on paper or other planar on material and also to determine the position of a stylus by means to range finder.

U.S. Pat. No. 5,825,675 teaches an apparatus and configuration method for a small, hand-held computing device.

U.S. Pat. No. 5,828,011 introduces high voltage stylus for a portable computer.

U.S. Pat. No. 5,889,512 is a description of an extendible-stylus.

U.S. Pat. No. 5,945,981 shows a wireless input device, for use with a computer, employing a movable light-emitting element and a stationary light-receiving element.

U.S. Pat. No. 6,046,737 describes a computer input stylus and thickness control system.

The above patented inventions differ from the present invention because they fail to describe or claim at least one combination of the following: features depicted in the present invention: simplicity, ease of use and a capable stylus.

The numerous innovations described above in the prior art do not address the obvious as this invention does.

### SUMMARY OF THE INVENTION

The present invention generally involves the field of technology pertaining to a stylus in the form of a typical marking pen resembling the tip of an inkless ballpoint.

It is remarkably responsive and does not appear to mar or scratch the screen.

In general, the object of this presentation is to introduce a truly simple and easy to use stylus for a hand help computer, which is easily portable and simple to use.

The invention uses a cylindrical hollow stylus body/plastic or metallic which contains a hole for insertion of a stem with a felt tip.

The ideal stylus is lightweight compact and easily stored for use with a hand held computer.

The present invention solves all these problems.

### List of Reference Numerals

### Utilized in the Drawing

1) Grooves to hold stem in place.
2) Stylus body.
3) Solid-cylindrical plastic or metallic
4) Hole to place stem tip.
5) Stem
6) Felt Tip

### BRIEF DESCRIPTION OF THE DRAWINGS

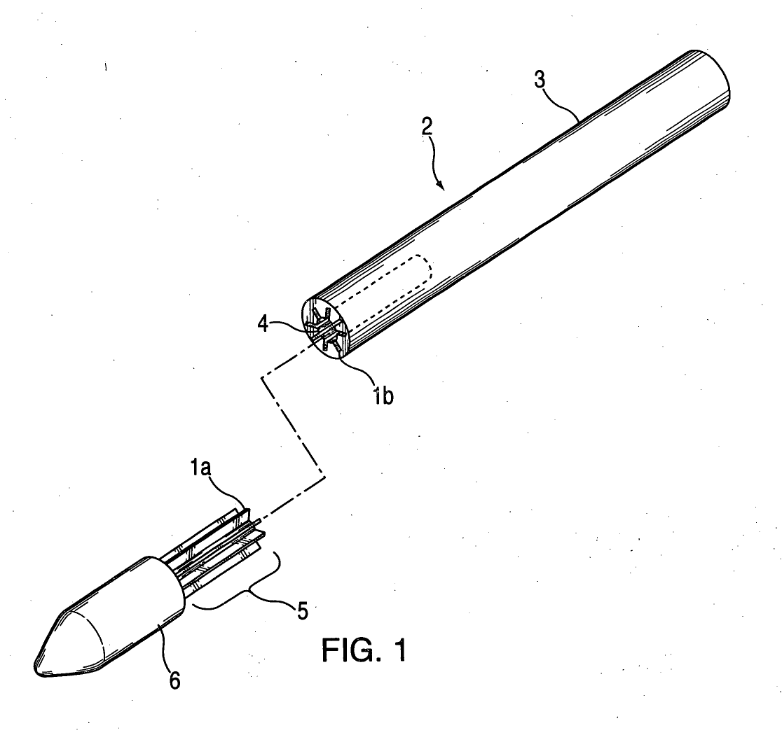

FIG. 1—Front view of the stylus body (2, 3) without the stylus stem (5) stylus felt tip (6) inserted and front view of the stylus tem (5) and felt tip (6).

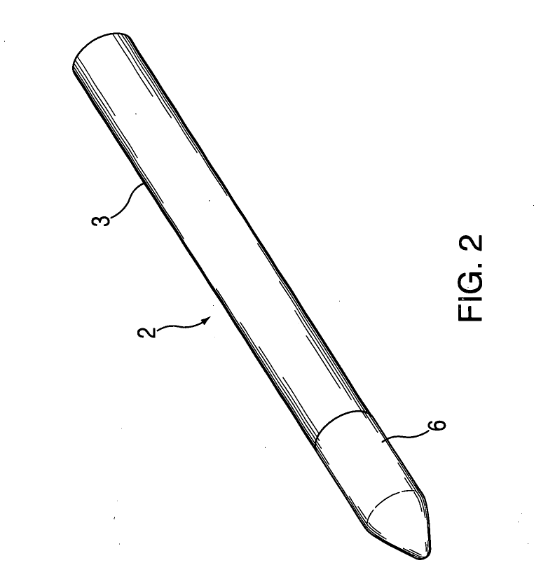

FIG. 2, Front view of the stylus body (2) (3) with the stylus site (5) and felt tip inserted (6).

Groves (1) hold the stem in place when not being used.

### DESCRIPTION OF THE PREFERRED EMBODIMENT

Referring to FIG. 1 which is a front view of the stylus cylindrical body (2/3_without the stylus stem (5) and felt tip (6) and grooves to hold the stem in place (1). The stylus body (2) is a cylindrical plastic or metallic (3) hollow shaft to hold the stylus stem (5) and felt tip (6).

Referring to FIG. 2, the stylus stem (5) and felt tip (6) are inserted into the stylus body (2) which is a cylindrical plastic, or virtually hollow shaft (3) with the stylus stem (5) inserted and the felt tip (6) protruding to form a tip similar to an inkless ballpoint to touch the surface of hand held computer which does not scratch or mar the surface of the computer.

1. A stylus for a handheld computer comprising:
A) A stylus body which is a hollow cylinder made of plastic;
b) A stem with a felt tip as a marking tool.

2. The stylus in claim 1, where the stylus body is made of metal.

3. The stylus body of claim 1, where the stem with the felt tip is inserted into the body, to function as a marking tool for a hand held computer.
